(19) United States
(12) Patent Application Publication
(10) Pub. No.: US 2026/0342068 A1
(43) Pub. Date: Oct. 29, 2026

(54) UNIVERSAL CABLE DISCONNECT DEVICE

(71) Applicant: Hoenisch Enterprises LLC, Eldersburg, MD (US)

(72) Inventors: Ian P. Hoenisch, Eldersburg, MD (US); James B. Weiner, Eldersburg, MD (US)

(21) Appl. No.: 19/186,895

(22) Filed: Apr. 23, 2025

(51) Int. Cl. H02G 7/04; H02G 1/04; H02G 7/18

(52) U.S. Cl. CPC H02G 7/04; H02G 1/04; H02G 7/18

(57) ABSTRACT

Disclosed herein is a universal cable disconnect device for disconnecting and reconnecting items under tension and processes for using said device. The device can include a mounting plate, a first member attached to the mounting plate, the first member defining one or more first openings, and a sliding member coupled to the first member, the sliding member defining one or more second openings, where at least one of the one or more second openings can be configured to align with at least one of the one or more first openings. A length of the universal cable disconnect device can be extended based on sliding the sliding member in a direction opposite the mounting plate. The device can also include a cable holder coupled to the sliding member that can be configured to retain a cable until a threshold amount of tension may be applied to the device.

### TECHNICAL FIELD

This disclosure generally describes devices, systems, methods, and techniques related to disconnecting and reconnecting wires under tension.

### BACKGROUND

During inclement weather and/or under tension, power lines and other cables, wires, and/or lines can disconnect. Reconnecting these lines can be a complex task that often requires specialized training and equipment, making it dangerous for a user to attempt. It can take hours or days for professional workers to come to the cite of the disconnection and reconnect the lines. As a result, the user, as well as other users, can remain without power or other resources for extended periods of time, which not only can result in safety concerns but also health concerns for the user(s). When the lines are disconnected, they may also hang loosely from where they once connected. This can cause safety hazards for the user and/or their property, including but not limited to electrocution, injuries, fire, and/or other situations that may require emergency response.

### SUMMARY

The disclosure generally describes devices, systems, methods, and techniques for safely and easily disconnecting and reconnecting wires or other lines under tension. As an illustrative example, a power connection from a street to a house can become disconnected if a branch falls on the power connection wire. Traditionally, only a professional worker, such as an electrician, could reconnect the power connection wire to restore power to the house. The disclosed technology provides a universal cable disconnect and reconnect device that can allow for any user, such as a homeowner, to reconnect the wire(s) themselves, without the assistance of the professional worker and without extensive training or knowledge in this area. Although the disclosure is described from the illustrative perspective of disconnecting and reconnecting electric power lines and similar wires, the disclosed technology can also be used in other use cases. For example, the disclosed technology can be used for disconnecting any mechanical items and/or tension wires upon some threshold level of tension (e.g., stress on the items and/or wires) and quickly and easily reconnecting such items and/or wires after the tension has been removed. As a merely illustrative example, a tension wire on a boat can be quickly reconnected when the wire breaks away under a threshold level of tension/stress when using the disclosed technology. A user can then easily reconnect the tension wire on the boat, as described herein.

One or more implementations described herein can include a universal cable disconnect device that can include mounting plate, a first member attached to the mounting plate, the first member defining one or more first openings, a sliding member coupled to the first member, the sliding member defining one or more second openings, where at least one of the one or more second openings can be configured to align with at least one of the one or more first openings, where a length of the universal cable disconnect device can be extended based on sliding the sliding member in a direction opposite the mounting plate, and a cable holder coupled to the sliding member, the cable holder being configured to retain a cable until a threshold amount of tension may be applied to the universal cable disconnect device.

The universal cable disconnect device can include one or more of the following features. For example, the cable holder can be pivotably coupled to the sliding member. The first member can be pivotably attached to the mounting plate. The cable holder can define an opening configured to detachably secure the cable to the cable holder. The one or more first openings can be defined by a surface of the first member and the one or more second openings can be defined by a surface of the sliding member. When the at least one of the one or more second openings aligns with the at least one of the one or more first openings, the aligned openings can be configured to receive one or more shear pins. Sometimes, the threshold amount of tension can be greater than a sum of shear pin strengths of the one of more shear pins. Sometimes, the one or more shear pins can have different shear strengths. The sliding member can also include a housing that can be configured to receive at least a portion of the first member within the housing. The universal cable disconnect device can be part of a kit, and the kit further can include: a first set of fasteners for securing the mounting plate to a surface, a second set of fasteners for securing the cable holder to the sliding member, a group of shear pins, and an instruction manual.

One or more implementations described herein can include a universal cable disconnect device having: a mounting plate, a first member attached to the mounting plate, the first member defining one or more first openings, a sliding member coupled to the first member, the sliding member defining one or more second openings, where at least one of the one or more second openings can align with at least one of the one or more first openings, and an opening attached to an end of the sliding member that can be configured to retain a cable until a threshold tension may be applied to the universal cable disconnect device.

The universal cable disconnect device can include one or more of the following features. For example, the device can also include a cable holder coupled to the sliding member. The cable holder can be configured to retain the cable until the threshold amount of tension may be applied to the universal cable disconnect device. The cable holder can be pivotably coupled to the sliding member. The first member can be pivotably attached to the mounting plate. When the at least one of the one or more second openings aligns with the at least one of the one or more first openings, the aligned openings can be configured to receive one or more shear pins. The sliding member can further include a housing that can be configured to receive at least a portion of the first member within the housing.

One or more implementations described herein can include a method for assembling a universal cable disconnect device, the method including: removably affixing a sliding member to a first member of the universal cable disconnect device such that one or more first openings defined in the first member can be substantially aligned with one or more second openings defined in the sliding member, inserting a shear pin into at least one of the aligned first and second openings, and detachably securing a cable to the sliding member.

The method can optionally include one or more of the following features. For example, the method can also include pivotably coupling a cable holder to a distal end of the sliding member. The cable holder can be configured to releasably retain the cable until a threshold amount of tension may be applied to the universal cable disconnect device. The sliding member can include a housing that can be configured to receive at least a portion of the first member within the housing when the sliding member may be removably affixed to the first member. The method further can include inserting a group of shear pins into the aligned first and second openings. One or more of the group of shear pins can have different shear strengths.

The devices, system, and techniques described herein may provide one or more of the following advantages. For example, the disclosed technology can allow for any user or layman to replace a broken tension wire and reconnect the wire without specialized knowledge or skills. This can allow for a power/wire restoration time to be shortened.

As another example, when pressure/stress/tension is applied to existing wires, the wires and/or end connectors can break, deform, and/or otherwise cannot be reused. The wires would have to be replaced by a skilled worker, which can drive up the cost and time needed for replacing the wires and restoring power. The disclosed technology can solve this problem by providing a simple, easy, and inexpensive technique for any user/layman to reconnect the wires. Since the disclosed technology can break under a threshold level of tension, the wires may not be broken or deformed. As a result, the user can simply reconnect the wire to the disclosed technology and thus reuse the wire.

Moreover, the disclosed technology can be modified to be larger or smaller in size, thicker, and/or longer. The dimensions of the disclosed technology can be adjusted based on a specific use of the technology. Similarly, a user can fully customize a threshold level of tension that would cause the disclosed technology to ‘break’ based on their use case by selecting and choosing a weight of shear pins or similar pins used with the disclosed technology. As a result, the disclosed technology can be easily adapted at a low cost to fit any desired use case and/or need of the user.

Furthermore, although the device disclosed herein is described in the context of retaining one or more cables and/or wires, this description is merely illustrative and is not intended to be limiting. The device can be used for connecting any two surfaces or items such that they can be separated or detached by applying a force or tension to the device, without causing breakage or damage to the surfaces or items. The two surfaces or items can be easily and conveniently reconnected thereafter. For example, in some implementations, the tension cable on a boat that holds the mast up can detach during high winds. Using existing systems, the tension cable and/or the mast may experience damage or breakage. However, the disclosed technology can provide an improved solution in ensuring that the tension cable and/or the mast remain undamaged and quick for reassembly. Using the disclosed technology, the tension cable may break or detach while causing the mast to fold down without further ripping or breakage. In some illustrative implementations, the device can be used to retain water lines and/or hoses. In yet some implementations, the device can be used to connect two sides of a sliding door that in case of emergency can be pushed apart (e.g. the pushing force breaks the shear pins or shear bolt in the device).

The details of one or more implementations are set forth in the accompanying drawings and the description below. Other features and advantages will be apparent from the description and drawings, and from the claims.

### BRIEF DESCRIPTION OF THE DRAWINGS

FIG. 1A is a perspective view of a universal cable disconnect device.

FIG. 1B is another perspective view of a universal cable disconnect device.

FIG. 1C is a perspective view of a disassembled universal cable disconnect device.

FIG. 1D is another view of a universal cable disconnect device that is adjusted at a pivot point of the universal cable disconnect device.

FIG. 1E is another view of a universal cable disconnect device that is adjusted at a pivot point of the universal cable disconnect device.

FIG. 2 is a side view of a universal cable disconnect device when used for retaining a cable.

FIG. 3 is a side view of a universal cable disconnect device having a pin storage.

FIG. 4A is a conceptual diagram of a universal cable disconnect device that can be used to retain a cable.

FIG. 4B is another conceptual diagram of the universal cable disconnect device of FIG. 4A once a threshold level of tension has been applied to the universal cable disconnect device.

FIG. 5 is a flowchart illustrating a process for using a universal cable disconnect device.

In the present disclosure, like-numbered components of various embodiments generally have similar features when those components are of a similar nature and/or serve a similar purpose, unless otherwise noted or otherwise understood by a person skilled in the art.

### DETAILED DESCRIPTION OF ILLUSTRATIVE EMBODIMENTS

This disclosure generally relates to a universal cable disconnect device and processes for using said device. The device can include two portions that can be removably affixed to each other with one or more shear pins. When tension is applied to the device (or a cable that is attached to the device) in excess of a predetermined threshold level of tension, the shear pins may break. When the shear pins break, the two portions of the device may separate from each other. Advantageously, the disclosed device is designed to release under pressure (e.g., tension, weight) rather than breaking completely, where a complete breakage may require professionals and/or expertise to reassemble the device and restore power or any other use associated with the cable or item that was attached to the device.

The device can be mounted to a structure. In some implementations, a base of the device can be mounted to the structure in a fixed position and using one or more fastening mechanisms described herein. The base may also remain attached to the structure when the two portions of the device separate in response to excess tension being applied to the device (or the cable attached thereto). In some examples, the device can be used to hold or retain a cable that, under existing cable holding configurations, can be damaged due to excess tension exerted on the cable, for example by strong gusts of wind. With the disclosed device, on the other hand, when the portions of the device separate from the excessive tension applied thereto (or to the cable), the cable can simply be released and thus dangle from the device mounted to the structure, rather than breaking or tearing. The cables with the existing cable holding configurations could be damaged such that professional expertise would be required to not only replace the cable, but also reconfigure the cable in the existing cable holding configuration to restore power (or whatever other use is associated with the cable). The disclosed device, on the other hand, provides for simple, intuitive, and safe disassembly and assembly of the cable with the device to ensure that the power can be restored quickly and without the need for professional expertise.

In some implementations, the device can include at least two portions. A first portion can be affixed to a structure, for example a building, a pole, a table, a wall, a tree, and/or another structure. A second portion of the universal disconnect device can be slidably coupled to the first portion so that at least a section of the first portion is adjacent to another section of the second portion. Both portions can define openings, which can be aligned with each other by sliding or positioning the second portion, over, or otherwise in alignment with the first portion of the universal disconnect device.

The openings that are aligned can be configured to receive one or more shear pins, which can be customizable by a user and can vary based on a threshold tension that may be applied to the device. In some implementations, a force and/or tension may be applied to the device and/or to cables attached thereto, thereby causing the shear pin(s) to break or otherwise release. As a result, the cable(s) can be released from the device. Such release allows for the device to be easily and quickly reconfigured by any user to return functionality of the cable(s) and/or other components that may be held or otherwise affixed to the device. The force and/or tension can be due to a gust of wind and/or an animal or person pulling at the cables or otherwise causing tension to any portion of the device and/or the cable(s) attached thereto.

The shear pins described herein can be configured to retain the first portion to the second portion of the device. When the tension and/or force applied to any portion or component of the device (or the cable(s)) exceeds the threshold tension that the sheer pins can withstand, the sheer pins break. This can cause the second portion to be free to slide away from the first portion, thereby detaching and de-configuring the device without causing damage to the cable(s). As a result, the second portion may fall to the ground. This can relieve the tension that is applied to the cables, thereby reducing or otherwise eliminating a risk that the cable(s) will break, tear, or otherwise be inoperable without maintenance from a professional industry worker.

In some implementations, the second portion may include a holder (e.g., a cable holder) that can be configured to detachably receive one or more items (e.g. cables, water lines, hoses, doors). The device may be used with a variety of different types of cables, including but not limited to co-axial cables, power lines, telephone lines, clothes lines, ropes, wires, and/or other cables with different thicknesses, weights, and/or materials. In some implementations, thin wires can be inserted into small openings of the holder, while thicker cables can be inserted into one or more larger openings and may be disposed to rest in a groove of the device. Although the disclosed technology is described from the perspective of retaining cables, the disclosed technology can also be used in different use cases and with different types of components, materials, and/or structures. The term cable is an illustrative term and the cables described herein are merely illustrative examples that are not intended to be limiting.

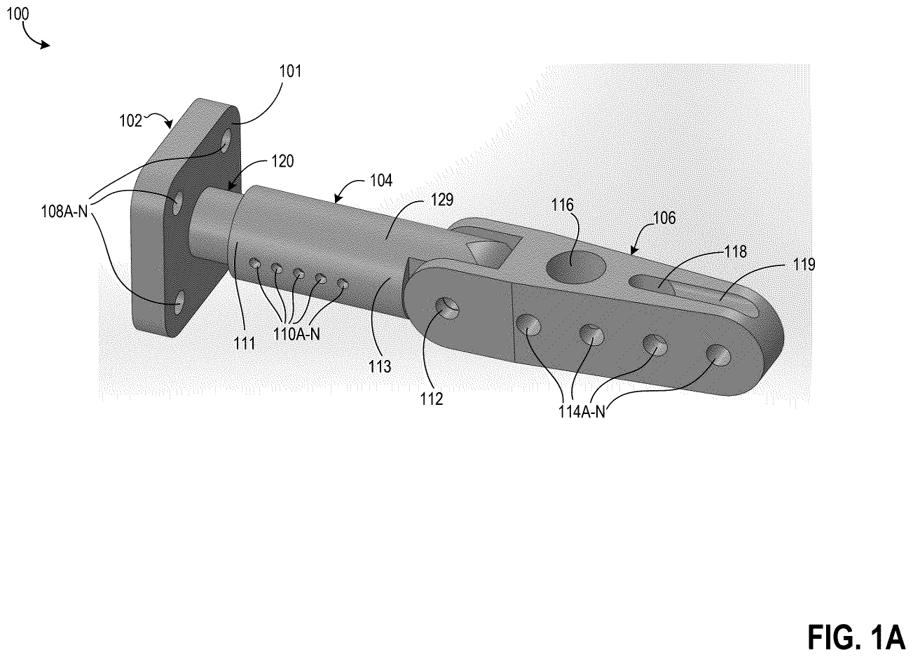

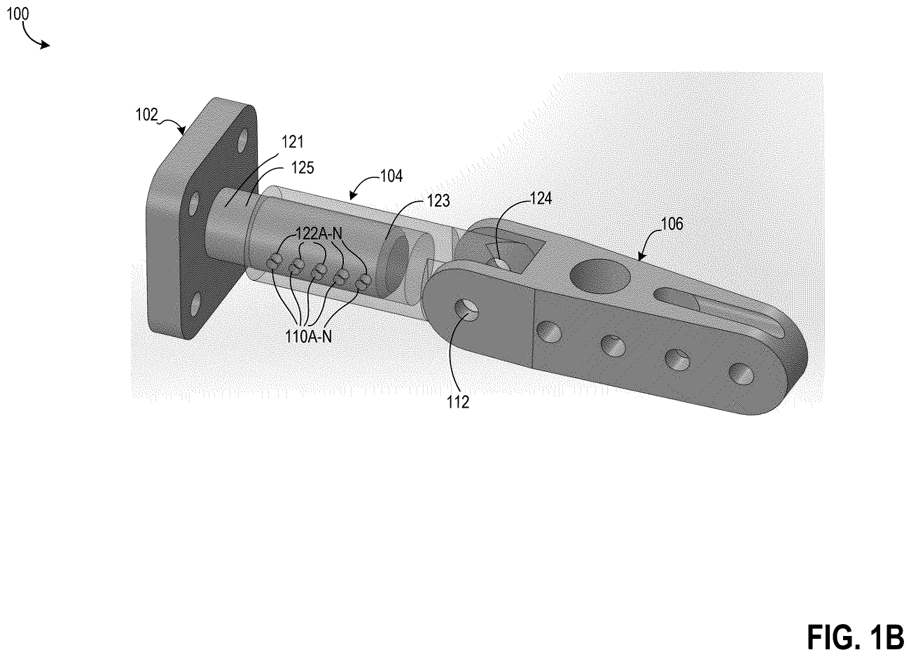

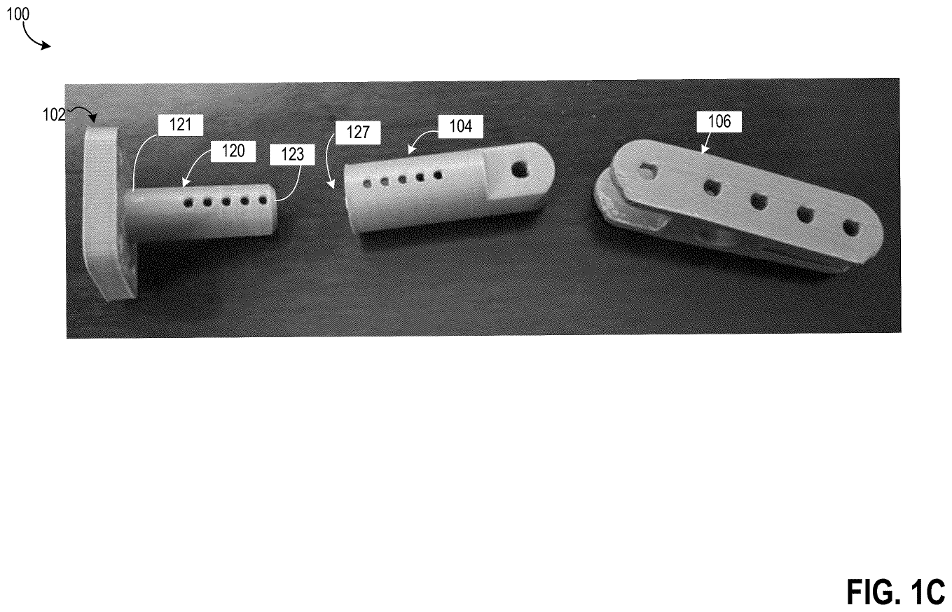

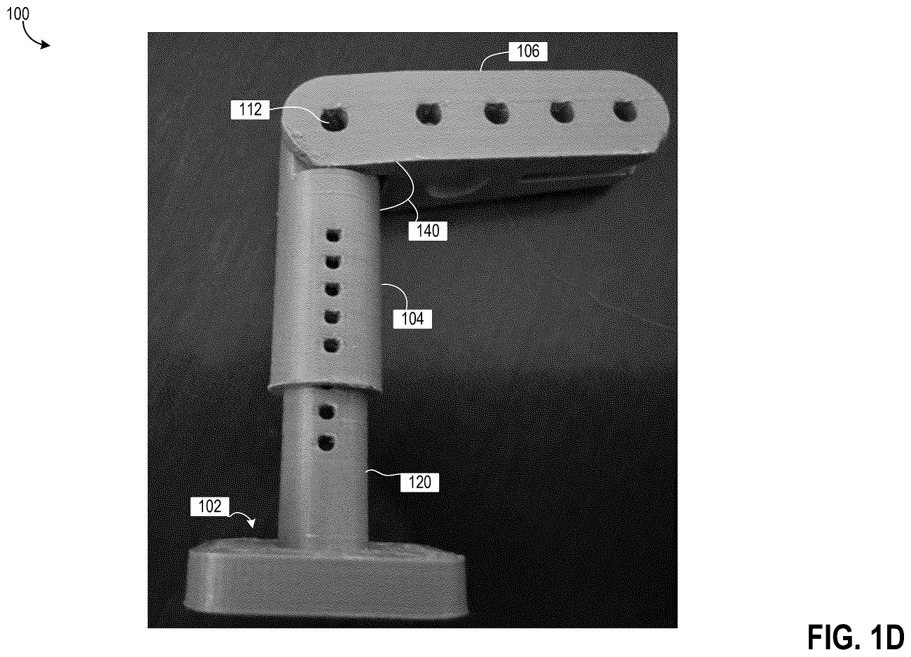

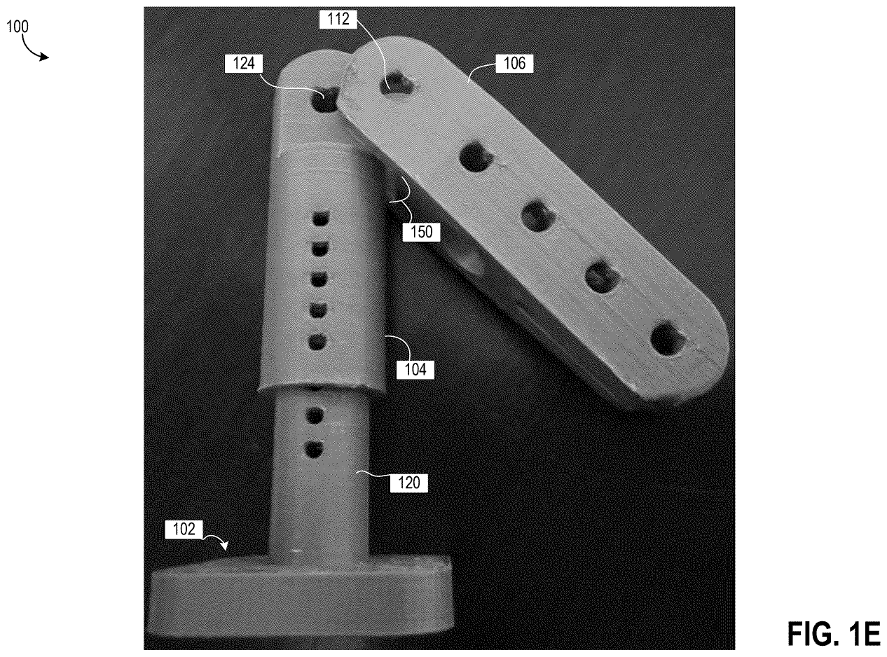

Referring to the figures, FIGS. 1A and 1B are perspective views of a universal cable disconnect device 100, FIG. 1C is a perspective view of the device 100 when it is disassembled, and FIGS. 1D and 1E are views of the device 100 when it is adjusted at a pivot point 112 of the device 100. The universal cable disconnect device 100 can include a base 102 having a mounting plate 101 and a first member 120. The first member 120 can also be a safety disconnect and/or a quick reconnect component of the device 100. The first member 120 can be alternatively referred to as a first member, a first portion, internal tube, inner sleeve, and/or inner chamber. In some implementations, the first member 120 can be cylindrically-shaped, a rectangular prism, a bar, flat, and/or any other shape that allows for at least 2 surfaces to touch and have a break/shear point where said surfaces touch. In some implementations, the first member 120 can be hollow. Sometimes, the first member 120 may be solid.

The first member 120 can include a first end 121 and a second end 123. The second end 123 of the first member 120 is distal from the mounting plate 101. The first end 121 of the first member 120 is the end proximal to the mounting plate 101 The first end 121 of the first member 120 can be fixedly attached to the mounting plate 101. In some implementations, the first end 121 can be pivotably attached to the mounting plate 101. The first member 120 can also define one or more openings 112A-N, as shown in FIG. 1B, which may be disposed on an outer surface 125 of the first member 120. The openings 112A-N can include one or more holes, cavities, notches, grooves, slots and/or any combination thereof. In some implementations, the first member 120 can include at least one opening 112A. Sometimes, the first member 120 can include more than one opening, such as 2 openings 112A-B, 3 openings 112A-C, and/or any n number of openings 112A-N.

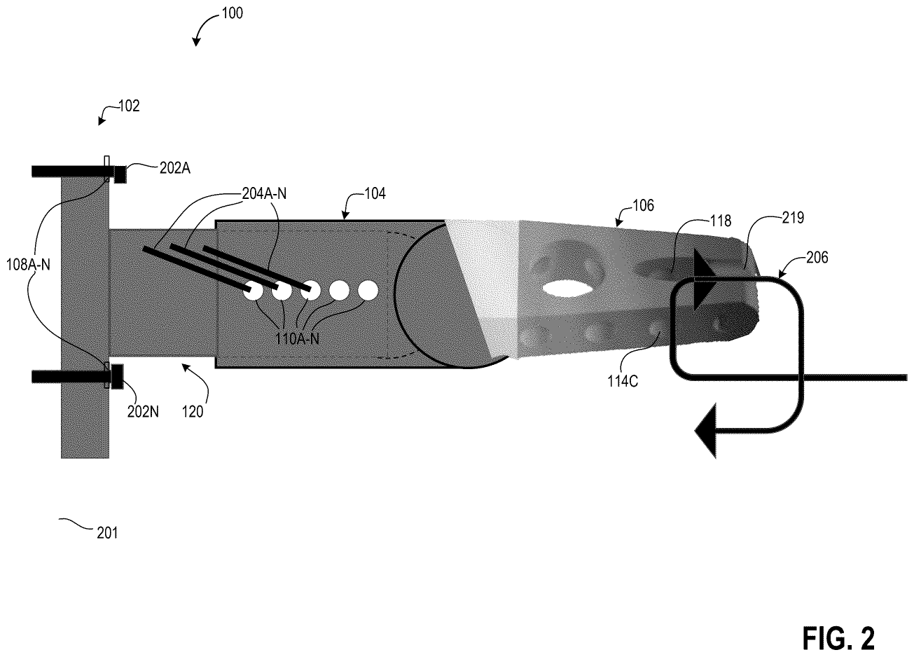

In some implementations, the base 102 of the device 100 can define one or more mounting openings 108A-N. The mounting openings 108A-N can be configured to receive one or more fasteners (not depicted) to fixedly attach the mounting plate 101 to a structure (e.g., a pole, a wall, a door frame, a door, the siding on a building, a table, a post, or any other structure). Refer to at least FIG. 2 for further discussion about the fasteners. The fastener(s) can include but is not limited to a nail, a bolt, a screw, and/or any implement that can be configured to secure the mounting plate 101 to a desired structure for real-time use.

The universal cable disconnect device 100 can also include a sliding member 104. The sliding member can include a first end 111 and a second end 113. The second end 113 of the sliding member 104 can be distal from the first member 120. The first end 111 of the sliding member 104 can be the end proximal to the first member 120. The first end 111 of sliding member 104 can be slidably coupled to the second end 123 of first member 120.

In some implementations, the sliding member 104 can be a housing that includes an opening 127 or cavity at first end 111 that is configured to receive the second end of the first member 123, as shown in FIG. 1B. Additionally or alternatively, the sliding member 104 can be configured to receive at least a portion of the first member 120 within the cavity or the housing. In some implementations, the first member 120 and the sliding member 104 can be disposed such that a portion of the first member 120 is adjacent to and abuts a portion of sliding member 104. For example, in some implementations, the first member 120 can be a bar or rectangular cuboid and the sliding member 104 can be a bar. In some illustrative implementations, the first member 120 can include a flat surface and the sliding member 104 can also include a flat surface. The first member 120 and the sliding member 104 can be disposed such that the flat surface of the first member 120 contacts the flat surface of the sliding member 104.

The sliding member 104 can define one or more openings 110A-N disposed on a surface 129 of the sliding member 104. When aligned with the one or more openings 112A-N (refer to FIG. 1B) defined by the first member 120, the one or more openings 112A-N that are aligned can receive the shear pin(s) (refer to at least FIG. 2 for further discussion) . In some implementations, a larger quantity of aligned openings 110A-N, 112A-N can enable the device 100 to receive a larger quantity of shear pins, and subsequently to retain a higher threshold weight for the shear pins as compared to the device having a smaller quantity of aligned openings 110A-N, 112A-N. In some implementations, the alignment of the larger quantity of openings 110A-N, 112A-N can be achieved by pushing the sliding member 104 towards the mounting base 102 such that the first end 111 of the sliding member 104 is flush with and perpendicular to a surface of the mounting base 102. Additionally or alternatively, moving the sliding member 104 closer to the mounting plate 101, using the greater number of aligned openings 110A-N, 112A-N, can reduce an overall length of the device 100 measured from the mounting plate 101 to the pivot point 112.

In some implementations, a smaller quantity of the aligned openings 110A-N, 112A-N can enable the device 100 to receive a smaller quantity of the shear pins described herein. Alignment of the smaller quantity of the openings 110A-N, 112A-N can be achieved by extending the sliding member 104 in a direction opposite the surface of the mounting base 102. Additionally or alternatively, using a smaller number of the aligned openings 110A-N, 112A-N positions the sliding member 104 farther away from the mounting plate 101, thereby resulting in a longer device length measured from the mounting plate 101 to the pivot point 112.

The universal cable disconnect device 100 can include a cable holder 106. Although the cable holder 106 is described herein as being used to retain cables, this is merely an illustrative example. The cable holder 106 can be configured to retain any other type of material or object described herein. In some implementations, the cable holder 106 can be an adapter or other type of holder, which can be configured to retain other materials including but not limited to electrical wires, water lines, and/or hoses. The cable holder 106 can be coupled to the sliding member 104 at the second end 113 of the sliding member 104. Sometimes, the second end 113 of the sliding member 104 can be fixedly coupled to the cable holder 106. Additionally or alternatively, the second end 113 of the sliding member 104 can be pivotably coupled to the cable holder 106. In some implementations, the pivot point 112 defined by the cable holder 106 can be aligned with a pivot point 124 defined by the sliding member 104. When aligned, a fastener (not depicted) can be inserted through openings defined by the pivot points 112 and 124. The fastener can be configured to secure the cable holder 106 to the sliding member 104 at a desired angle, for example angle 140 in FIG. 1D and/or angle 150 in FIG. 1E. The pivot point 112 can be configured to reduce or otherwise eliminate stress from fixedly mounting the base 102 of the device 100 to a structure. The pivot point 112 can also allow for flexibility such that when load and/or tension is applied to any portion of the device 100 or a cable attached thereto, the device 100 does not simply separate from the structure it is attached to. In some implementations (not depicted), the device 100 can include one or more joints that are similar to the pivot point 112 along a length of the first member 120. For example, the first member 120, proximate the base 102, can include at least one swivel joint which can be configured to allow additional flexibility and resilience against various tensions that may be applied to the device 100 or a cable attached thereto. Sometimes, the first member 120 can include a swivel joint on an end that is closest to the base 102 and another swivel joint that is at an end opposite of the base 102.

In some implementations, the cable holder 106 may be secured at the desired angle 140, as shown in FIG. 1D. The desired angle can be anywhere within a range of 0 to 360 degrees. As an illustrative example shown in FIG. 1E, the angle 150 can be an acute angle. In some implementations, the angle 140 and/or 150 that the cable holder 106 makes with the sliding member 104 may vary depending on an orientation of the universal connect device 100. For example, if the universal connect device 100 is mounted to a horizontal surface, such as a table, the angle 140, 150 can be appropriately selected to enable securing a cable to the cable holder 106. The cable may be looped through an opening 114A-N, 116, 118 and disposed to rest on a groove 119 of the cable holder 106. When the universal connect device 100 is mounted to a vertical surface, such as the side of a building in another illustrative example, the angle 140 can be appropriately selected to enable securing the cables to the cable holder 106.

The cable holder 106 can define the openings 114A-N, 116, 118, and/or any combination thereof. The openings 114A-N, 116, and/or 118 can be configured to receive and secure one or more cables to the cable holder 106, and thus the device 100. In some implementations, the openings 114A-N can include but are not limited to openings configured to receive thin wires, such as clothes lines and/or telephone lines. Sometimes, the opening 116 can be configured to receive a thicker cable than the openings 114A-N. The openings 116 118 can include grooves 119 or other types of cavities and/or holes that can be configured to prevent a cable resting in the groove 119 from slipping out of said groove 119. A cable may be inserted into one of more openings 114A-N, 116, 118 of the appropriate size and secured to the cable holder 106 by looping it around and through one or more other openings 114A-N, 116, 118. As an illustrative example, a cable can be inserted into the opening 116 and disposed to rest in the groove 119. In another illustrative example, a cable may be inserted into the opening 116 and wrapped around an exterior of cable holder 106 to retain the cable thereto. One or more other configurations are also possible.

While this disclosure describes openings as structures that receive and secure cables to the cable holder 106, this description is not intended to be limiting. The cable holder 106 can include other structures and/or components that can be configured to receive and secure a cable or a combination of cables to the cable holder 106. Examples include but are not limited to a protrusion, hook, retainer, clip, clasp, peg, and/or other fastening mechanism.

A number, size, and/or position of the openings 114A-N, 116, and/or 118 can be modified at time of manufacture of the device 100. For example, the universal disconnect device 100 may be used with power cables and therefore can have the cable holder 106 with the one or more openings 114A-N, 116, and/or 118 that can be large enough to accommodate power cables or other cables of a heavier weight and durability against potential weather conditions. As another example, the device 100 can be used with clothes lines and therefore may be manufactured with one or more smaller openings 114A-N, 116, and/or 118. In some implementations, the device 100 can be manufactured with a same size of the openings 114A-N, 116, and/or 118. The device 100 can be adapted for different use cases by using different weighted shear pins. For example, where the device 100 is used with power cables, a user can apply heavier shear pins than where the device 100 is used with clothes lines. As another example, additionally or alternatively, where the device 100 is used with power cables, the user can apply a greater quantity of the shear pins than where the device 100 is used with clothes lines.

In some implementations, device 100 can be manufactured to be larger in size and/or smaller, to have thicker walls and/or thinner walls, to have a longer sliding member and/or first member and/or a shorter sliding member and/or first member, etc. The ease of manufacturing said device 100 (e.g., using three-dimensional printing techniques) can allow for accurate customization of the device 100 for particular use cases. In some implementations, one or all dimensions of the device 100 can be scaled at the time of manufacture and/or based on the intended use. For example, in implementations with heavier cable loads, the device 100 can be made larger and/or manufactured with thicker walls. Additionally or alternatively, the device 100 can be made out of a variety of materials or a combination of materials. In some implementations, the device 100 can be made of materials including but not limited to plastic, metal, wood, and/or a combination thereof.

FIG. 2 is a side view of the universal cable disconnect device 100 when used for retaining a cable 206. In this illustrative example, the cable 206 can be inserted into the opening 114C, pulled though the opening 118, to rest on a grooved portion 119 of a cable head 219. Fasteners 202A-N can be inserted into the mounting openings 108A-N defined by the mounting base 102 to securely attach the mounting base 102 to a structure 201. In some implementations, the fasteners 202A-N can include but are not limited to bolts, screws, nails, rods, zip-ties, and/or any other similar implement that can secure the device 100 to the structure 201. The structure 201 can include but is not limited to a side of a building, a tree, a pole, a post, a fence, a tabletop, and/or another surface.

The sliding member 104 can be positioned such that the openings 110A-N can be aligned with the openings 112A-N of first member 120 of the device 100. One or more shear pins 204A-N can be inserted into one or more of the aligned openings 110A-N. The number of shear pins 204A-N used and the strength of each shear pin 204A-N can be determined and/or selected by the user, manufacturer, and/or distributor of the device, and can vary based on a use. For example, if the device 100 is intended to remain intact when subjected to a predetermined threshold tension, a collective shear pin strength of the shear pins 204A-N can be larger than the threshold tension As another example, if the device 100 is intended to disassemble when a predetermined threshold tension is exceeded, the collective sheer pin strength of the shear pins 204A-N can be less than the threshold tension. For example, if the tension on a cable that is retained by the device 100 must not exceed 50 pounds (lb), the device 100 can be configured to disconnect when the tension applied to the device 100 is less than 50 lb. For example, 3 shear pins 204A-C having respective breaking points of 10 lb each can be inserted into the openings 110A-N. The 3 shear pins 204A-C in this example can result in the cable disconnecting to break after 30 lbs of tension is applied to the cable or the device 100. Similarly, the device 100 can be configured to disconnect when the tension applied to the device 100 is 40 lb by inserting 4 shear pins 204A-D in the openings 110A-N, where each shear pin 204A-D has a respective break point of 10 lb Other combinations of shear pin strengths and quantities are possible.

In some implementations, one shear pin 204A-N can be used. In some implementations, a plurality of the shear pins 204A-N can be used. Each of the shear pins 204A-N can have same or different shear pin strengths. If the predetermined threshold tension is larger than some threshold, multiple of the shear pins 204A-N may be used. Stronger shear pins can be used when the threshold tension is greater, as described above.

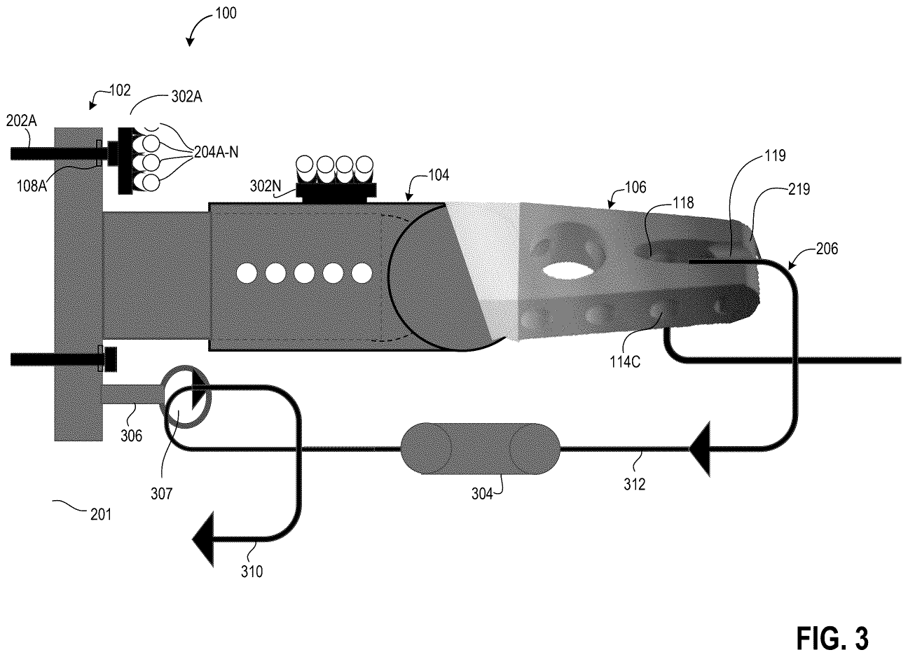

FIG. 3 is a side view of the universal cable disconnect device 100 having a pin storage 302A-N. The pin storage 302A-N may be fixedly or removably attached to the device 100. For example, where a portion of the device 100 is metal or a similar material, the pin storage 302A-N may have a magnetic material that causes the pin storage 302A-N to attach magnetically to an outer surface of the device 100. A user can configurably attach the pin storage 302A-N to any desired portion of the device 100. In some implementations, the pin storage 302A-N may be configured to attach to the mounting plate 101 or one or more of the fasteners 202A-N. The pin storage 302A-N can be configured to attach to a nearby structure, such as a side of a building or pole or other structure (e.g., a structure that the device 100 is mounted to). Advantageously, the pin storage 302A-N can be configured to retain one or more additional shear pins. As a result, if the device 100 is disassembled due to shear pins in the device 100 breaking under tension in excess of a threshold tension, a user can easily and quickly remove one or more of the shear pins in the pin storage 302A-N and use those pins to reassemble the device 100.

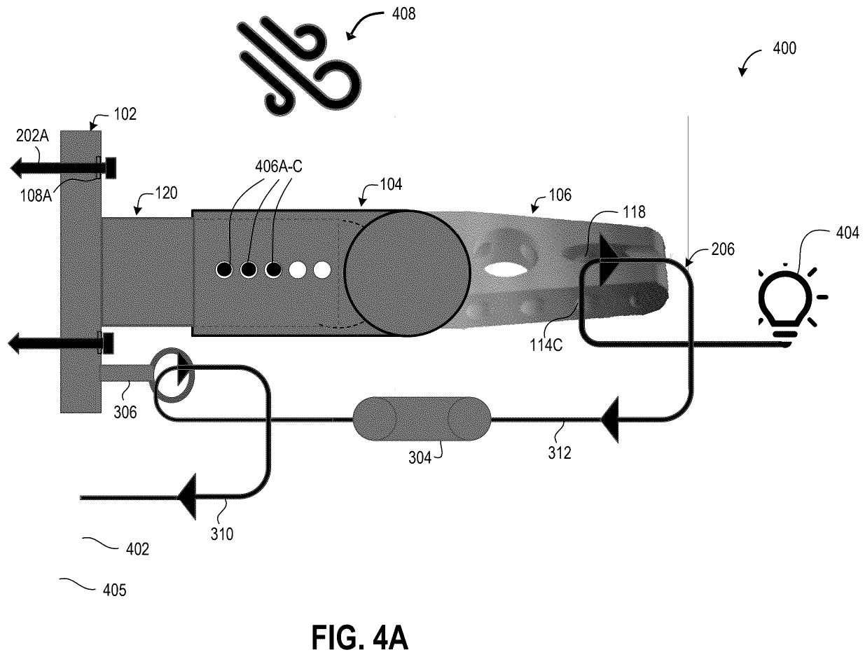

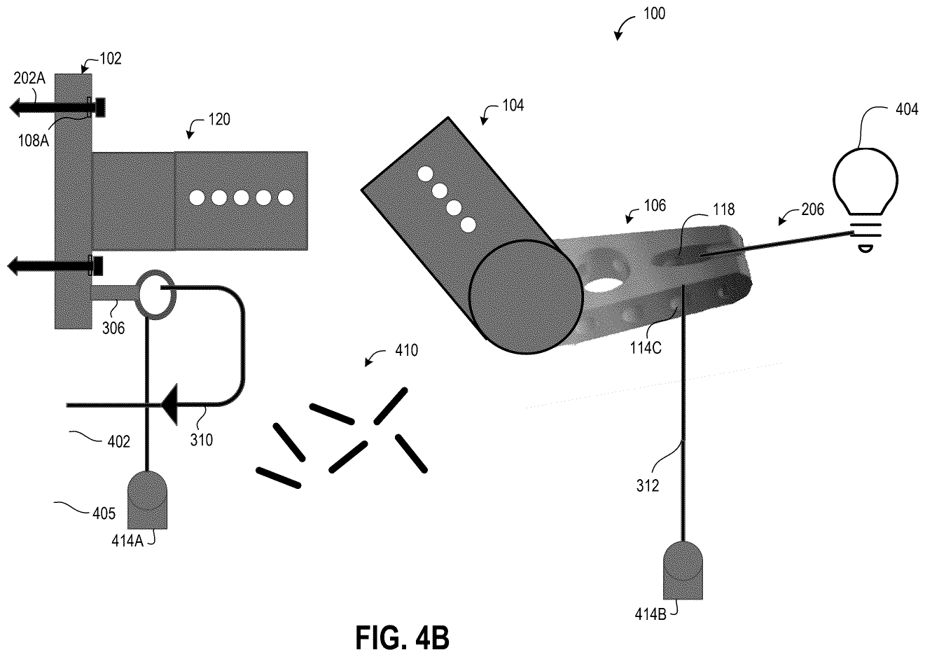

In some implementations, a cable clip 306 can be attached or otherwise affixed to the device 100. Additionally or alternatively, the cable clip 306 can be separate from the device 100, and can be configured to attach to a structure proximate to the device 100. The cable clip 306 can receive a cable 206. The cable 206 can include a first portion 310 and a second portion 312. The first portion 310 of the cable 206 can be inserted through the clip opening 307 and/or looping around the cable clip 306. In some implementations, the first portion 310 can be attached to the second portion 312 via a quick disconnect barrel connector 304. The benefit of using the quick disconnect barrel connector 304 is that the first portion 310 can separate from the second portion 312 without breakage or tearing of the cable 206, e.g., when excess force or tension is applied to the cables (refer to at least FIG. 4B for further discussion about the quick disconnect barrel connector 304).

FIG. 4A is a conceptual diagram of an implementation 400 where the universal cable disconnect device 100 can be used to retain the cable 206 that powers a light bulb 404. The first portion 310 of the cable 206 can connect to a power source 402, for example a power outlet or battery. In some implementations, the power source 402 can be attached to a structure 405 (e.g., house, building, table, or other surface).

One or more shear pins 406A-C can be configured to retain the first member 120 to the sliding member 104 of the device 100. The shear pins 406A-C can be selected by a user to enable the device 100 to withstand a threshold level of tension that may be applied to the device 100 (e.g., by weather conditions such as a gust of wind 408).

FIG. 4B is another conceptual diagram of the universal cable disconnect device 100 of FIG. 4A once a threshold level of tension has been applied to the device 100. When the threshold level of tension is exceeded, shear pins 410 break and can fall away from the device 100. This can cause the sliding member 104 to be released from the first member 120 of the device 100, thereby safely disconnecting or disassembling components of the device 100. The sliding member 104 can separate from the first member 120, such as by falling away from the device 100 (e.g., falling to the ground). This can cause the quick disconnect barrel connector 304 to separate into two portions 414A and 414B, which can temporarily disrupt a flow of power to the light bulb 404, thereby causing the light bulb 404 to turn off.

As a result of using the universal disconnect device 100, the first portion 310 and the second portion 312 of cable 206 may safely separate under excess tension without breakage that would require a professional to fix the cables 206 and restore power. As a result, the device 100 can be configured to avoid damage to the cable 206, e.g., breaking or tearing. Re-assembling the system 400 can then be performed by a layman user, without expertise and without assistance of a professional. For example, the re-assembling may be performed by re-positioning the sliding member with respect to the first member 120 of the device 100. Once at least one of the shear pin openings 110A-N is aligned with at least one of the shear pin openings 112A-N, new shear pins can be inserted into the aligned openings 110A-N and 112A-N. The cable 206 can be re-assembled by plugging first portion 414A of the quick disconnect barrel connector 308 into the second portion 414B. Power can be restored quickly and efficiently to the light bulb 404 without incurring additional downtime or costs associated with waiting for and hiring a professional to return power and fix any broken cables.

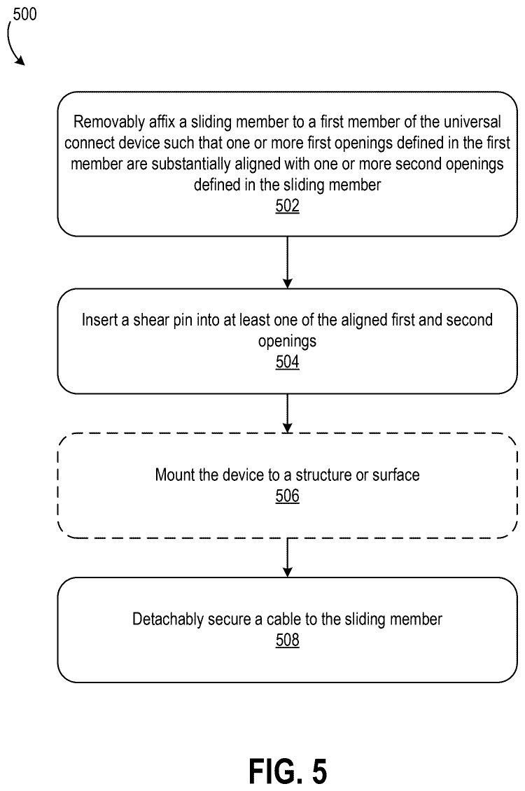

FIG. 5 is a flowchart illustrating a process 500 for using the universal cable disconnect device 100. In some implementations, the process 500 can be performed by a user, such as a layman. The process 500 can be performed without requiring the user to have experience, expertise, or knowledge in how to assemble and disassemble configurations for retaining cables. For illustrative purposes, the process 500 is described from the perspective of assembling the universal cable disconnect device 100 described in reference to at least FIGS. 1A, 1B, 1C, 1D, and 1E.

In block 502, the sliding member 104 can be removably affixed to the first member 120 such that one or more of the first openings 112A-N defined in the first member 120 are substantially aligned with one or more of the second openings 110A-N defined in the sliding member 104.

In block 504, at least one shear pin or shear bolt can be inserted into at least one of the aligned first and second openings 110A-N, 112A-N. The user can select which shear pins and a quantity of shear pins to use in block 504, which can vary based on a use of the device 100. As a merely illustrative example, the user may choose shear pin(s) having a weight that's 10-20% of a cable tension that is desired for the particular use. The shear pin(s) can shear off under threshold levels of tension, thereby causing the sliding member 104 to detach or otherwise separate from the first member 120 of the device 100 when more than a threshold level of tension is applied to any portion of the device 100 (and/or a cable attached to the device 100). In other words, the sliding member 104 can fall off of or otherwise detach from the first member 120 when more than the threshold level of tension that the shear pin(s) can withstand is applied to the device 100 or a cable attached thereto. Although the shear pin(s) is described with respect to the process 500, one or more other materials and/or mechanisms can be used that may break under threshold levels of tension described herein. As merely illustrative examples, cotter pins, latch and snaps, C clamps, or other similar materials can be used instead of or in addition to the shear pin(s) described herein.

Optionally, the device 100 can be mounted to a structure or surface, such as a house or building wall (block 506). For example, fasteners (e.g., screws) can be used to attach a base 102 of the device to the structure or surface. Sometimes, block 506 can be performed before or after any one or more other blocks shown and described in the process 500 of FIG. 5. For example, block 506 can be performed first in the process 500.

In block 508, a cable 206 can be detachably secured to the sliding member 104. For example, the cable 206 can be weaved through an opening or groove of a cable holder 106 or other portion extending from a distal end of the sliding member 104, which is opposite the base 102 of the device 100. Once the cable 206 is weaved through the opening or groove, it can be wrapped around said opening or groove to secure in place. In some implementations, the cable 206 can be looped through the opening or groove of the cable holder 106 then attached to a power source or other component that may be proximate the structure or surface (e.g., a light, a computer or other electronic device, a power box). In some implementations, multiple cables can be detachably secured to the cable holder 106 or other portion of the sliding member 104. For example, the cable holder 106 can include multiple small openings, which can be configured to receive smaller cables or wires, such as clothes lines. In yet some implementations, the cable 206 can be attached directly to the sliding member 104, by weaving the cable 206 through one or more of the openings 110A-N. This implementation can be preferred where the device 100 does not include the cable holder 106.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A universal cable disconnect device comprising:
a mounting plate;
a first member attached to the mounting plate, wherein the first member defines one or more first openings;
a sliding member coupled to the first member, wherein the sliding member defines one or more second openings, wherein at least one of the one or more second openings is configured to align with at least one of the one or more first openings, wherein a length of the universal cable disconnect device is extended based on sliding the sliding member in a direction opposite the mounting plate; and
a cable holder coupled to the sliding member, wherein the cable holder is configured to retain a cable until a threshold amount of tension is applied to the universal cable disconnect device.

2. The universal cable disconnect device of claim 1, wherein the cable holder is pivotably coupled to the sliding member.

3. The universal cable disconnect device of claim 1, wherein the first member is pivotably attached to the mounting plate.

4. The universal cable disconnect device of claim 1, wherein the cable holder defines an opening configured to detachably secure the cable to the cable holder.

5. The universal cable disconnect device of claim 1, wherein the one or more first openings are defined by a surface of the first member and the one or more second openings are defined by a surface of the sliding member.

6. The universal cable disconnect device of claim 1, wherein when the at least one of the one or more second openings aligns with the at least one of the one or more first openings, the aligned openings are configured to receive one or more shear pins.

7. The universal cable disconnect device of claim 6, wherein the threshold amount of tension is greater than a sum of shear pin strengths of the one of more shear pins.

8. The universal cable disconnect device of claim 6, wherein the one or more shear pins have different shear strengths.

9. The universal cable disconnect device of claim 1, wherein the sliding member comprises a housing configured to receive at least a portion of the first member within the housing.

10. The universal cable disconnect device of claim 1, wherein the universal cable disconnect device is part of a kit, and wherein the kit further comprises: a first set of fasteners for securing the mounting plate to a surface, a second set of fasteners for securing the cable holder to the sliding member, a plurality of shear pins, and an instruction manual.

11. A universal cable disconnect device comprising:
a mounting plate;
a first member attached to the mounting plate, wherein the first member defines one or more first openings;
a sliding member coupled to the first member, wherein the sliding member defines one or more second openings, wherein at least one of the one or more second openings aligns with at least one of the one or more first openings; and
an opening attached to an end of the sliding member that is configured to retain a cable until a threshold tension is applied to the universal cable disconnect device.

12. The universal cable disconnect device of claim 11, further comprising a cable holder coupled to the sliding member, wherein the cable holder is configured to retain the cable until the threshold amount of tension is applied to the universal cable disconnect device.

13. The universal cable disconnect device of claim 12, wherein the cable holder is pivotably coupled to the sliding member.

14. The universal cable disconnect device of claim 11, wherein the first member is pivotably attached to the mounting plate.

15. The universal cable disconnect device of claim 11, wherein when the at least one of the one or more second openings aligns with the at least one of the one or more first openings, the aligned openings are configured to receive one or more shear pins.

16. The universal cable disconnect device of claim 11, wherein the sliding member comprises a housing configured to receive at least a portion of the first member within the housing.

17. A method for assembling a universal cable disconnect device, the method comprising:
removably affixing a sliding member to a first member of the universal cable disconnect device such that one or more first openings defined in the first member are substantially aligned with one or more second openings defined in the sliding member;
inserting a shear pin into at least one of the aligned first and second openings; and
detachably securing a cable to the sliding member.

18. The method of claim 17, further comprising pivotably coupling a cable holder to a distal end of the sliding member, wherein the cable holder is configured to releasably retain the cable until a threshold amount of tension is applied to the universal cable disconnect device.

19. The method of claim 17, wherein the sliding member comprises a housing configured to receive at least a portion of the first member within the housing when the sliding member is removably affixed to the first member.

20. The method of claim 17, wherein the method further comprises inserting a plurality of shear pins into the aligned first and second openings, wherein one or more of the plurality of shear pins have different shear strengths.
